(19) United States
(12) Patent Application Publication
(10) Pub. No.: US 2008/0062981 A1
(43) Pub. Date: Mar. 13, 2008

(54) Method for modernizing the control of an elevator system

(76) Inventor: Bernhard Gerstenkorn, Ebikon (CH)

Correspondence Address: Klaus P. Stoffel;Wolff & Samson, One Boland Drive, West Orange, NJ, 07052, US

(21) Appl. No.: 11/900,282

(22) Filed: Sep. 10, 2007

(30) Foreign Application Priority Data
Sep. 12, 2006 (EP) 06120520.9

(51) Int. Cl. H04L 12/56

(52) U.S. Cl. 370/389

(57) ABSTRACT

In a method for modernizing the control of an elevator system with at least one terminal, the terminal is updated with a control data packet for modernizing the control functions of the elevator system that is stored on a mobile control data storage element. In this method, via a near-field radio connection that is generated within a predefined distance between the mobile control data storage element and the terminal, the control data packet is transmitted from the control data storage element to the terminal, and the control data packet deposited in a memory unit of the terminal.

### BACKGROUND OF THE INVENTION

The present invention relates to a method for modernizing the control of an elevator system that contains at least one terminal.

Usually, the control of an elevator system is updated with a control data package for modernizing the control functions of the elevator system at certain time intervals, for example during service work. Such a data package is usually stored on a storage element such as a memory card. Thus, for example, from EP 0 857 684 B1, a memory card is known that has a storage element on which are stored the control data that are necessary for the function of the elevator system, and to maintain permanent connection with the central control unit during installation and continuous operation of the elevator system, without which memory card the elevator system is not capable of functioning. In other words, the memory card is permanently inserted in a slot, so that through a permanent interface, permanent access to the control data is possible.

However, this has the disadvantage that to modernize the control functions of the elevator system, the memory card with the former control data must be removed, and a new memory card with the updated control data inserted. This requires increased maintenance outlay since maintenance personnel must obtain access to the central control unit and open and close the respective housing.

Also known are elevator systems with destination call terminals that are positioned on the individual stories and each provided with an RFID reader unit and not centrally accessible via a remote maintenance system. This has the disadvantage that the respective destination call terminals must be maintained individually, For this purpose, the destination call terminal must be opened and the complete RFID reader unit exchanged. Also known is the operation of destination call terminals with plug-in cards so that also in this case, to modernize the functions of the destination call terminal, exchange of the plug-in card is necessary. In an elevator system with many stories, this requires a high maintenance outlay not only in terms of the amount of work for the personnel, but also in terms of the number of new plug-in cards that has to be made available.

### SUMMARY OF THE INVENTION

The task of the invention is to provide a method for modernizing an elevator system in which the control functions of the elevator system can be updated with simple means.

To solve this task, in a method for modernizing the control of an elevator system with at least one terminal, that is updated with a control data package for modernizing the control functions that is stored on a mobile control data memory element, according to the present invention the control data packet is transmitted from the mobile control data memory element to the terminal by means of a near-field radio connection that is generated between the mobile control data memory element and the terminal, and the control data packet is stored in a memory unit of the terminal.

The method according to the invention makes possible the transmission of up-to-date control data packets by simple means via a wireless near-field radio connection in a limited range around the terminal. In other words, by means of the method according to the invention, a software update can be transmitted to the destination call terminal, especially to an RFID receiver unit that is designed and adapted for such a near-field radio connection, in that the mobile control data memory element such as, for example, an RFID memory card or a mobile telephone in the immediate vicinity of the destination call terminal, is held against the RFID receiver unit of the destination call terminal and, after activation of the near-field radio connection, the control data packet can be transmitted to the destination call terminal. The control data packet can subsequently be saved in a memory unit of the destination call terminal and the near-field radio connection deactivated, for example very simply by the person carrying the control data storage element moving away from the destination call terminal and beyond the range of the radio connection.

The method according to the invention thus allows multiple use of a control data storage element for multiple transmission of the control data packet to a plurality of destination call terminals for modernization of the control functions of any number of elevator systems. It is also not necessary for the control data storage element to remain permanently on or in the destination call terminal. The usually necessary change of control cards can be dispensed with. The maintenance outlay is substantially reduced not only through the obviation of work for the removal and insertion, but also through the reduction of the material costs through obviation of the manufacture of new control cards. The solution according to the invention also does not require any additional outlay for securing the elevator system against misuse, since interrogation of an authorization code can be integrated without problem.

The method is not limited to destination call terminals, but can also be used on electronic door locks etc., in fact on all devices with an RFID or NFC reader that are defined as a terminal.

In an advantageous further embodiment of the method, it is foreseen that for the mobile control data storage element a memory card, in particular an RFID memory card, that is carried by a person is used with a transmission device. Such a memory card can be executed in either the active variant, which means for example with integrated battery, or in the passive variant, in which the memory card is activated and supplied with current by an electromagnetic field that is radiated by the destination call terminal. It is advantageous to use as the mobile control data memory element a mobile telephone. In this manner, for example, an authorization interrogation can take place via the mobile telephone, in which a corresponding code is entered via the keypad field of the mobile telephone and can be transmitted to the destination call terminal.

Advantageously, the distance within which the near-field radio connection is generated is less than approximately 1 m, particularly less than approximately 30 cm. Such a limited range of the near-field radio connection requires the control data storage element to be positioned in the immediate vicinity of the destination call terminal, whereby additional security against misuse is provided.

In a further embodiment, the control data packet is transmitted from the destination call terminal to a central control unit of the elevator system and/or to further destination call terminals. Since the connections between the individual destination call terminals of different or identical stories, and the connections from the destination call terminals to the central control unit, are normally by means of wire, these connections can be used for transmission of the control data packet. In this way, the need for maintenance personnel to visit each individual destination call terminal and update it by means of the control data storage element is avoided. This allows the personnel and time outlay for modernization of the control functions to be further reduced.

Expediently, before transmission of the control data packet the authorization is verified and, if this verification of the authorization is successful, the destination call terminal is enabled by means of an enabling code. This measure serves to secure against misuse. According to one embodiment, the enabling code is entered by means of an entering device on the destination call terminal. The entering device is expediently the keypad field for entering destination call stories that is present in any case. Alternatively, the enabling code can be transmitted to the destination call terminal by means of the near-field radio connection. Thus, if a mobile telephone is used as the control data storage element, the enabling code can be entered via the keypad field of the mobile telephone.

Other features and advantages of the present invention will become apparent from the following description of the invention that refers to the accompanying drawings.

### BRIEF DESCRIPTION OF THE DRAWINGS

FIG. 1 shows diagrammatically a cross section of an elevator system 10.

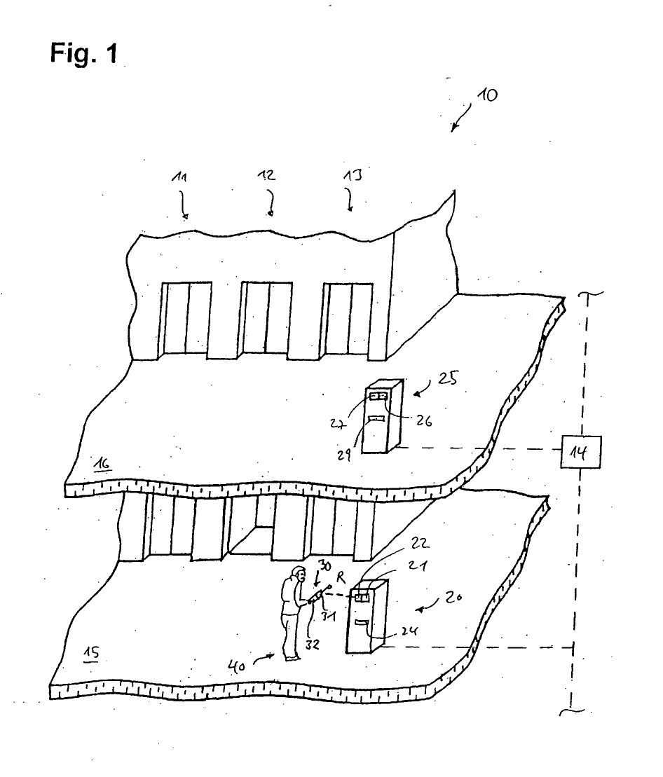

### DETAILED DESCRIPTION OF THE INVENTION

The elevator system 10 has three elevators 11, 12, 13. In the vicinity of the elevator system 10, on the first story 15 there is a destination call terminal 20, and on the second story 16 a destination call terminal 25. To control the entire elevator system 10, a central control unit 14 is provided that via corresponding communication lines is in data communication with the destination terminals 20, 25 and other destination call terminals in the other stories that are not shown.

The destination call terminal 20 comprises an RFID receiver unit 22, a memory unit 21, and a keypad field 24. Correspondingly, the destination call terminal 25 comprises a memory unit 26, an RFID receiver unit 27, and a keypad field 29. The RFID receiver units 22, 27 are designed in such manner that in conjunction with a control data storage element 30 that is described in greater detail below, they can generate a near-field radio connection.

To modernize in the course of time the control of the elevator system 10 that is made possible by the central control unit 14 and the destination call terminal 20, 25, the following method is executed:

An authorized person 40, as for example maintenance personnel responsible for the elevator installation 10 or another person responsible for the building, who carries the mobile control data storage element 30 in the form of an RFID memory card 30 or mobile telephone, approaches the destination call terminal 20. The memory card 30 also contains a transmitter unit 31, including a transmitting device as, for example, an antenna. As soon as the memory card 30 that is held by the person 40 is in the immediate vicinity of the destination call terminal 20, which means that the distance R between the transmission unit 31 and the receiver unit 22 is, for example, less than approximately 30 cm, a near-field radio connection is generated between the transmission unit 31 and the receiver unit 22. This near-field radio connection is designed in such manner that an adequate transmission bandwidth for transmission of the control data packet is available. As an additional security measure it can be foreseen that the person 40, to be able to generate such a near-field radio connection at all, must first enter an enabling code by means of the keypad field 24.

After complete transmission of the control data packet from the control data storage element 30 to the destination call terminal 20, in other words from the transmission unit 31 to the receiver unit 22, the control data packet is deposited in the memory unit 21. On completion of this operation, the person 40 with the control data storage element can move away from the destination call terminal 20 and repeat the operation on the second story 16 for the destination call terminal 25. Alternatively, the data conductor that is present between the destination call terminal 20, 25 and the central control unit 14 can be used to transmit the control data packet that is stored in the storage unit 21 to the memory unit 26 of the destination call terminal 25.

The method according to the invention for modernizing the control of the elevator system 10 is especially characterized in that modernization of the control functions can be performed in simple manner by means of a wireless near-field radio connection and the mobile control data storage element 30 that is carried by a person. By this means, among other things the exchange of plug-in cards including opening and closing the housing of the destination call terminal 20, 25, can be obviated.

Although the present invention has been described in relation to particular embodiments thereof, many other variations and modifications and other uses will become apparent to those skilled in the art. It is preferred, therefore, that the present invention be limited but by the specific disclosure herein, but only by the appended claims.

1. A method for modernizing the control of an elevator system with at least one terminal, comprising the steps of: updating the terminal with a control data packet for modernizing control functions of the elevator system, which control data packet is deposited on a mobile control data storage element; transmitting the control data packet from the mobile control data storage element to the terminal via a near-field radio connection that is generated within a predefined distance between the mobile control data storage element and the terminal; and depositing the control data packet in a memory unit of the terminal.

2. The method according to claim 1, wherein a memory card with a transmission device that is carried by a person is used as the mobile control data storage element.

3. The method according to claim 2, wherein the memory card is an RFID memory card.

4. The method according to claim 1, wherein a mobile telephone is used as the mobile control data storage element.

5. The method according to claim 1, wherein the predefined distance within which the near-field radio connection is generated is less than approximately 1 m.

6. The method according to claim 5, wherein the predefined distance is less than about 30 cm.

7. The method according to claim 1, further including transmitting the control data packet of the terminal to a central control unit of the elevator system and/or to further terminals.

8. The method according to claim 1, including verifying authorization before transmission of the control data packet and enabling the terminal with an enabling code if verification of the authorization is successful.

9. The method according to claim 8, including entering the enabling code via an input device on the terminal.

10. The method according to claim 8, including transmitting the enabling code to the terminal by way of the near-field radio connection.
